(19) United States
(12) Patent Application Publication
(10) Pub. No.: US 2014/0282516 A1
(43) Pub. Date: Sep. 18, 2014

(54) PROVIDING EXECUTION ACCESS TO FILES NOT INSTALLED IN A VIRTUALIZED SPACE

(71) Applicant: International Business Machines Corporation, Armonk, NY (US)

(72) Inventor: J. Mark McConaughy, Austin, TX (US)

(73) Assignee: International Business Machines Corporation, Armonk, NY (US)

(21) Appl. No.: 13/838,496

(22) Filed: Mar. 15, 2013

(51) Int. Cl. G06F 9/455

(52) U.S. Cl. CPC G06F 9/455
USPC 718/1

(57) ABSTRACT

Provided are techniques for providing a virtual machine (VM) workload partition (WPAR) with an versioned operating system (OS) that is different than a native OS associated with a logical partition (LPAR) corresponding to the WPAR, wherein the versioned OS is an earlier version of the native OS; detecting an executable file associated with the versioned OS that has been designated to be overlaid with a corresponding executable from the native OS; generating a link to the corresponding executable; and installing the link in the WPAR rather than the executable file.

### FIELD OF DISCLOSURE

The claimed subject matter relates generally to computing systems and, more specifically, to techniques for providing a virtual file space access to files that are not installed within the space.

### BACKGROUND OF THE INVENTION

Unlike logical partitions (LPARs), in which computing resources are partitioned with respect to hardware, a virtualized file system is partitioned with respect to software. In addition, unlike LPARs which may have different operating systems, virtualized file system spaces include virtualized operating system (OS) environments within a single instance of an OS. One example of a virtualized file system space, used as an example throughout this Specification, is a workload partition (WPAR). It should be understood that although the claimed subject matter is described with respect to WPARs, the same principles also apply to other types of virtualized file system spaces.

Basically, there are two types of WPARs, system WPARs and application WPARs. Typically, a system WPAR partitions system resources and an application WPAR isolates and executes one or more application processes. The following description is based upon system WPARs. Each WPAR has a regulated share of system resources and may have unique networks and file systems. In addition, each WPAR may have separate administrative and security domains, with each WPAR having a unique root user, regular users and passwords, its own services such as inetd, cron and syslog, and can be stopped and started on its own. A WPAR does not typically share writable file systems with other WPARs or the global system. WPARs share an operating system and may share underlying file systems, real or virtual disk adapters, processors, memory, paging space and a real or virtual network card.

Although WPARs within a particular LPAR share one OS, different WPARs within a LPAR may run different versions of a particular OS. Such a WPAR is called a “versioned” WPAR. A versioned WPAR typically runs an older version of an OS than the global, or “native,” LPAR. The versioned WPAR contains commands, shared libraries, and so on of whatever level of OS it is running. However some commands, such as, but not limited to, device drivers and other kernel extensions, within a versioned WPAR are “overlaid,” which means that the WPAR runs the corresponding command in the global LPAR. Typically, this is necessary to keep certain commands in sync with the kernel on the global LPAR because WPARs do not include their own kernel.

When a file is overlaid in the WPAR, the file is renamed, typically by adding a suffix to the name and a symbolic link to a copy of the native runtime execution wrapper is created with the name of the original file, or legacy binary. Typically, there is one copy of the native execution wrapper for each target binary's directory path. In addition, actions are taken to reflect these changes in administrative files that an install facility uses to track the state of all installed files on the system by replacing references to the original name with the new name with the added suffix. The wrapper mechanism typically works as follows: 1) The path of the native library is pre-pended to the LIBPATH parameter; 2) The name of the executable that invoked the wrapper is identified; and 3) A special new “native runtime exec( ) interface” is called to execute the corresponding native binary.

### SUMMARY

As the Inventors herein have realized, the overlay mechanism described above assumes there is a file installed in the WPAR that is to be overlaid. Typically, there are base filesets explicitly installed in versioned WPARs and all the files are overlaid so that the latest version of those files present in the global LPAR are executed. In this situation, there may be executables from these filesets that are installed in the WPAR but never executed. In addition, these techniques tie the service stream for the versioned WPAR product to the OS support process. Every time there is an update to one of those base filesets, a repackaging of the versioned WPAR product filesets is triggered.

Provided are techniques for providing a virtual machine (VM) workload partition (WPAR) with an versioned operating system (OS) that is different than a native OS associated with a logical partition (LPAR) corresponding to the WPAR, wherein the versioned OS is an earlier version of the native OS; detecting an executable file associated with the versioned OS that has been designated to be overlaid with a corresponding executable from the native OS; generating a link to the corresponding executable; and installing the link in the WPAR rather than the executable file.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of a computing system architecture that may implement the claimed subject matter.

FIG. 2 is a block diagram of a workload partition (WPAR) Overlay Manager (OM), introduced above in FIG. 1, in greater detail.

FIG. 3 is a flowchart of one example of a Create WPAR process that may implement aspects of the claimed subject matter.

FIG. 4 is a flowchart of one example of a Fileset (FS) Overlay process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks. It should also be understood that, although described with respect to WPARs, the claimed subject matter is equally applicable to other types of virtualized file system spaces.

Turning now to the figures, FIG. 1 is a block diagram of one example of a computing system architecture 100 that may incorporate the claimed subject matter. A computing system 102 includes a central processing unit (CPU) 104, coupled to a monitor 106, a keyboard 108 and a pointing device, or “mouse,” 110, which together facilitate human interaction with the elements of computing system 100 and client system 102. Also included in client system 102 and attached to CPU 104 are computer-readable storage mediums (CRSMs), specifically a CRSM_{—}1 111, a CRSM_{—}2 112 and a CRSM_{—}3 113. Each of CRSMs 111-113 may either be incorporated into client system 102, i.e. an internal device, or attached externally to CPU 104 by means of various, commonly available connection devices such as but not limited to, a universal serial bus (USB) port (not shown).

CRSM_{—}1 111 is illustrated storing a logical partition (LPAR) 114, which includes an operating system (OS) 116, a shared memory 118, a WPAR Overlay Manager (OLM) 120 and a number of workload partitions (WPARs), i.e. a WPAR_{—}1 121, a WPAR_{—}2 122 and a WPAR_{—}3 123. In the following examples, WPAR OLM 120 is configured to implement the claimed subject matter. In addition, WPAR_{—}1 121 is a versioned WPAR, i.e., running a less current version of OS 116 than LPAR 114. In conjunction with the versioning of WPAR_{—}1 121, WPAR_{—}1 121 includes overlaid filesets (OFS), i.e. an OFS 126. In this example, WPAR_{—}2 122 and WPAR_{—}3 123 are native WPARs, i.e. running the same version of OS 116 as LPAR 114. The implementation and maintenance of WPAR 121 is explained in more detail below in conjunction with FIGS. 2-4.

Computing system 102 is also coupled to the Internet 130, which is in turn coupled to two (2) other computing systems, i.e. a client 132 and a server 134. Although in this example, computing system 102 and computing systems 132 and 134 are communicatively coupled via the Internet 130, they could also be coupled through any number of communication mediums such as, but not limited to, a local area network (LAN) (not shown). Computing devices 132 and 134 are used as examples of resources that may be available to computing system 102 and serve as potential access points to computing system 102. It should be noted that a typical computing system would typically include many addition elements, but for the sake of simplicity only a few are shown.

FIG. 2 is a block diagram of WPAR OLM 120, introduced above in FIG. 1, in greater detail. WPAR OLM 120 includes an input/output (I/O) module 140, a data module 142, an overlay module 144 and operation logic 146. Although there may be other components of WPAR OLM 120, for the sake of simplicity, only components 140, 142, 144 and 146 are illustrated and described. For the sake of the following examples, logic associated with WPAR OLM 120 is assumed to execute on one or more processors (not shown) of computing system 102 (FIG. 1) and to be stored on CRSM_{—}1 111 (FIG. 1). It should be understood that the claimed subject matter can be implemented in many types of computing systems and data storage structures but, for the sake of simplicity, is described only in terms of computing system 102 and system architecture 100 (FIG. 1). Further, the representation of WPAR OLM 120 in FIG. 2 is a logical model. In other words, components 140, 142, 144 and 146 may be stored in the same or separates files and loaded and/or executed within computing system 102 and architecture 100 either as a single system or as separate processes interacting via any available inter process communication (IPC) techniques.

I/O module 140 handles any communication WPAR OLM 1240 has with other components of computing system 102 and architecture 100. Data module 142 is a data repository for information and parameters that WPAR OLM 120 requires during operation. Examples of the types of information stored in data module 142 include WPAR data 152. version data 154, fileset data 156 and option data 158.

WPAR data 152 stores information relating to established WPARs such as WPARs 121-123, including, but not limited to, various resources that may be allocated to each of WPARs 121-123 and whether or not the WPAR is a versioned or native WPAR. Version data 154 stores information on the specific version of OS 116 that each WPAR 121-123 is currently executing. Fileset data 156 stores information about the filesets installed in each of WPARs 121-123 as well as the specific filesets that have been overlaid in accordance with the claimed subject matter. Option data 158 stores user and administrative operating parameters that may control the operation of WPAR OLM 120.

Overlay module 144 stores logic responsible for installing the appropriate filesets in versioned WPARs such as WPAR 121 in accordance with the claimed subject matter. Operation logic 148 stores logic associated with implementation of the claimed subject matter as well as logic responsible for the typical logic associated with the installation and updating of WPARs such as WPARs 121-123. Components 142, 144, 146, 152, 154, 156 and 158 are described in more detail below in conjunction with FIGS. 3-4.

FIG. 3 is a flowchart of one example of a Create WPAR process 200 that may implement aspects of the claimed subject matter. In this example, process 200 is associated with logic stored on CRSM_{—}1 111 (FIG. 1) in conjunction with WPAR OLM 120 (FIG. 1) and executed on one or more processors (not shown) of CPU 104 (FIG. 1) of computing system 102 (FIG. 1).

Process 200 begins in a “Begin Create WPAR” block 202 and proceeds immediately to a “Receive Request”block 204. During processing associated with block 204, a request to generate a new WPAR is received at WPAR OLM 120 (FIGS. 1 and 2). During processing associated with a “Generate WPAR” block 206, procedures that are familiar to those with skill in the relevant arts allocate and populate memory and update relevant files associated with the new WPAR are implemented.

During processing associated with a “Native WPAR?” block, a determination is made as to whether or not the WPAR requested during processing associated with block 204 and generated during processing associated with block 206 is native, i.e., configured to run the current version of OS 116, or non-native, i.e., configured to run an older version of OS 116. If non-native, control proceeds to a “Retrieve Overlay List” block 210. During processing associated with block 210, information that specifies those files and their corresponding filesets within the WPAR that need to be overlaid with current files corresponding to the current OS (see 154 and 156, FIG. 2) is retrieved.

During processing associated with a “Get Next File” block 212, the next file listed in the information retrieved during processing associated with block 210 is selected for processing. Of course, the during the first iteration through block 212, this would typically be the first file in the list. During processing associated with a “Generate Overlay” block 214, the file selected for processing during processing associated with block 212 is processed (see 250, FIG. 4). During processing associated with a “More Files?” block 216, a determination is made as to whether or not there are additional, unprocessed files listed in the information retrieved during processing associated with block 210. If so, control returns to block 212, the next file is selected for processing and processing continues as described above.

Finally, if during processing associated with block 216 a determination is made as that there are no more files to process or, if during processing associated with block 208, a determination is made that the WPAR being created is native, control proceeds to an “End Create WPAR” block 219 in which process 200 is complete.

FIG. 4 is a flowchart of one example of a Generate Overlay process 250 that may implement aspects of the claimed subject matter. Process 250 corresponds to Generate Overlay block 214 (FIG. 3) of Create WPAR process 200 (FIG. 3). Like process 200, in this example, process 250 is associated with logic stored on CRSM_{—}1 111 (FIG. 1) in conjunction with WPAR OLM 120 (FIG. 1) and executed on one or more processors (not shown) of CPU 104 (FIG. 1) of computing system 102 (FIG. 1).

Process 250 begins in a “Begin Generate Overlay” block 252 and proceeds immediately to a “Fileset (FS) Present?” block 254. During processing associated with block 254, a determination is made as to whether or not the file being processed (see 212, FIG. 3) is a member of a filesset that is already present in the WPAR being generated (see 206, FIG. 3). As explained above, information on the files of the WPAR (see 154 and 156, FIGS. 2 and 210, FIG. 3) includes the fileset to which the file belongs. It should also be noted that, although not illustrated in this particular diagram, if a particular file is not present and not part of a mandatory fileset, the file is not needed and therefore no overlay is created.

If the fileset is present, control proceeds to a “Save Original File” block 256. During processing associated with block 256, the file that is already installed is renamed, typically by adding a suffix to the original name. In addition, references to the file in any files that track the file for administrative purposes are also modified to reflect the new name so that, when the original file is to be updated, the original file is updated rather than the file identified by the link. If, during processing associated with block 254 a determination is made that the fileset to which the file belongs is not present, control proceeds to an “FS Mandatory?” block 258. During processing associated with block 258, a determination is made as to whether or not the fileset that was determined not to be present during processing associated with block 254 is a required fileset. If so, or if during processing associated with block 256 the original file has been saved under a new name, control proceeds to a “File Binary?” block 260. During processing associated with block 260, a determination is made as to whether or not the file being processed is binary or not, i.e. a script file. If the file is binary, control proceeds to a “Create Link to Runtime Execution Wrapper (RTEW)” block 262. During processing associated with block 262, a link to the RTEW is generated, having the original name of the file. If a determination is made, during processing associated with block 260, that the file being processed in not binary, then control proceeds to “Create Link to Global Script File (GSF)?” block 264. During processing associated with block 264, a link is created to the corresponding global script file. It should be noted that a script file does not need to employ a RTEW so the link points directly to the corresponding GSF of the native OS.

In addition, if a determination was made during processing associated with block 254, that the file was not present and during processing associated with block 258 that the file was mandatory, then the original file did not need to be renamed because the file was not in memory. In this manner, files that do not need to be installed and will never be used are not installed and do not consume computing resources.

Once a either link to a RTEW has been created during processing associated with block 262 or a link to a GSF created during block 264, control proceeds to an “End Generate Overlay” block 279 during which process 250 is complete. Files handled in accordance with the disclosed technology eliminate work the WPAR OLM 120 would typically need to perform because original files are not installed and thus do not need to be overlaid during updates. Concerns that overlaid files are over-written are also eliminated. In addition, any updates to files in the global LPAR 114 are automatically applied because the WPAR 121 will point to the updated binaries and scripts as soon as they are placed in the LPAR 121.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
providing a virtual machine (VM) workload partition (WPAR) with an versioned operating system (OS) that is different than a native OS associated with a logical partition (LPAR) corresponding to the WPAR, wherein the versioned OS is an earlier version of the native OS;
detecting an executable file associated with the versioned OS that has been designated to be overlaid with a corresponding executable from the native OS;
generating a link to the corresponding executable; and
installing the link rather than the executable file in the WPAR.

2. The method of claim 1, the generating further comprising:
detecting that the executable file is binary; and
creating the link such that the link references an runtime execution wrapper corresponding to the executable file.

3. The method of claim 1, the generating further comprising:
detecting that the executable file is a global script file (GSF); and
creating the link such that the link references the GSF.

4. The method of claim 1, the generating further comprising:
detecting that a copy of the executable file associated with the versioned OS is already installed in the versioned OS; and
saving the copy under a different name prior to creating the link.

5. The method of claim 4, further comprising:
detecting that the executable file is to be updated; and,
in response, updating the copy rather than a file corresponding to the link.

6. The method of claim 4, further comprising updating administrative files employed to facilitate an update of the executable file.

7. The method of claim 6, further comprising, in response to the update of the executable file, the copy is updated.

8. An apparatus, comprising:
a processor;
a non-transitive, computer-readable storage medium (CRSM) coupled to the processor;
a virtual machine (VM) workload partition (WPAR) loaded on CRSM, wherein the WPAR executes under an versioned operating system (OS) that is different than a native OS associated with a logical partition (LPAR) corresponding to the WPAR, wherein the versioned OS is an earlier version of the native OS; and
logic, stored on the CRSM and executed on the processor, for:
detecting an executable file associated with the versioned OS that has been designated to be overlaid with a corresponding executable from the native OS;
generating a link to the corresponding executable; and
installing the link rather than the executable file in the WPAR.

9. The apparatus of claim 8, the logic for generating further comprising logic for:
detecting that the executable file is binary; and
creating the link such that the link references an runtime execution wrapper corresponding to the executable file.

10. The apparatus of claim 8, the logic for generating further comprising logic for:
detecting that the executable file is a global script file (GSF); and
creating the link such that the link references the GS.

11. The apparatus of claim 8, the logic for generating further comprising logic for:
detecting that a copy of the executable file associated with the versioned OS is already installed in the versioned OS; and
saving the copy under a different name prior to creating the link.

12. The apparatus of claim 11, the logic further comprising logic for:
detecting that the executable file is to be updated; and,
in response, updating the copy rather than a file corresponding to the link.

13. The apparatus of claim 11, the logic further comprising logic for updating administrative files employed to facilitate an update of the executable file.

14. The apparatus of claim 13, the logic further comprising logic for, in response to the update of the executable file, the copy is updated.

15. A computer programming product, comprising:
a non-transitive, computer-readable storage medium (CRSM); and
logic, stored on the CRSM for execution on a processor, for:
maintaining a virtual machine (VM) workload partition (WPAR), wherein the WPAR executes under an versioned operating system (OS) that is different than a native OS associated with a logical partition (LPAR) corresponding to the WPAR, wherein the versioned OS is an earlier version of the native OS;
detecting an executable file associated with the versioned OS that has been designated to be overlaid with a corresponding executable from the native OS;
generating a link to the corresponding executable; and
installing the link rather than the executable file in the WPAR.

16. The computer programming product of claim 15, the logic for generating further comprising logic for:
detecting that the executable file is binary; and
creating the link such that the link references an runtime execution wrapper corresponding to the executable file.

17. The computer programming product of claim 15, the logic for generating further comprising logic for:
detecting that the executable file is a global script file (GSF); and
creating the link such that the link references the GSF.

18. The computer programming product of claim 15, the logic for generating further comprising logic for:
detecting that a copy of the executable file associated with the versioned OS is already installed in the versioned OS; and
saving the copy under a different name prior to creating the link.

19. The computer programming product of claim 18, the logic further comprising logic for:
detecting that the executable file is to be updated; and,
in response, updating the copy rather than a file corresponding to the link.

20. The computer programming product of claim 18, the logic for further comprising logic for updating administrative files employed to update the executable file so that, in response to an update to the executable file, the copy is updated.
